(19) United States
(12) Patent Application Publication
(10) Pub. No.: US 2008/0031441 A1
(43) Pub. Date: Feb. 7, 2008

(54) METHOD AND APPARATUS FOR FILTERING SIGNALS

(75) Inventors: KEITH BRAHO, MURRYSVILLE, PA (US); AMRO EL-JAROUDI, PITTSBURG, PA (US)

Correspondence Address: AKERMAN SENTERFITT, P.O. BOX 3188, WEST PALM BEACH, FL, 33402-3188, US

(73) Assignee: VOCOLLECT, INC., PITTSBURG, PA (US)

(21) Appl. No.: 11/462,872

(22) Filed: Aug. 7, 2006

(51) Int. Cl. H04M 9/08

(52) U.S. Cl. 379/406.08; 379/406.01

(57) ABSTRACT

A system (100) and method (300) are disclosed for filtering signals. A system that incorporates teachings of the present disclosure may include, for example, a speech processor (102) having an audio system (212) for audibly transmitting a rendition of a message, and for removing a portion of the rendered message embedded in a received signal as a result of at least one among electrical and electrical-magnetic interference between the rendered message and the received signal, thereby generating a filtered received signal. The audio system can capture the received signal while audibly transmitting the rendered message. Additional embodiments are disclosed.

### FIELD OF THE DISCLOSURE

The present disclosure relates generally to signal processing techniques, and more specifically to a method and apparatus for filtering signals.

### BACKGROUND

Audio circuits often suffer from a problem where the output signal is fed back into an input channel due to poor isolation. This feedback can be caused by any number of sources such as for example a leakage or crosstalk path in the audio circuit, audio loop back, an echo, and so on.

A need therefore arises for a method and apparatus for filtering signals.

### BRIEF DESCRIPTION OF THE DRAWINGS

FIG. 1 depicts an exemplary embodiment of a communication system;

FIG. 2 depicts an exemplary embodiment of a processor operating in the communication system;

FIG. 3 depicts an exemplary method operating in the processor; and

FIGS. 4-8 depict exemplary embodiments of the method operating in the processor.

### DETAILED DESCRIPTION

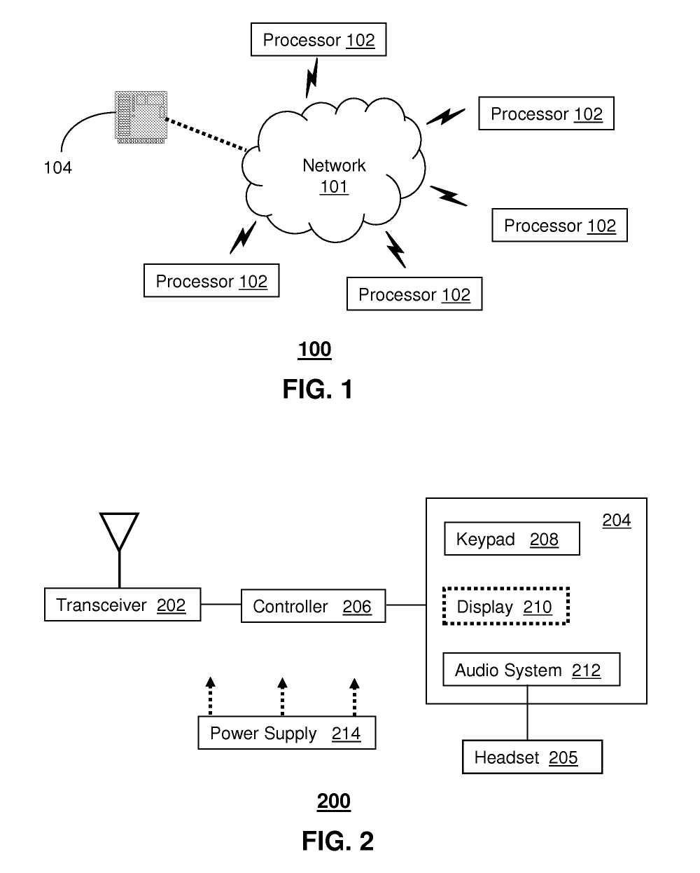

FIG. 1 depicts an exemplary embodiment of a communication system 100. The communication system 100 can comprise a number of processors 102 wirelessly coupled to a network 101 for communicating with a server 104. The speech processors 102 can utilize common wireless access technologies such as Bluetooth™, Wireless Fidelity (WiFi), Worldwide Interoperability for Microwave Access (WiMAX), Ultra Wide Band (UWB), software defined radio (SDR), Zigbee, or cellular for accessing the network 101. The network 101 can comprise a number of dispersed wireless access points that supply the speech processors 102 wireless communication services in an expansive geographic area according to any of the aforementioned wireless protocols. The server 104 can comprise a scalable computing device for performing the operations depicted in the present disclosure. The communication system 100 can have many applications including among others a means for task processing in a medical services environment, or managing logistics of a commercial enterprise such as inventory management, shipping, distribution, and so on.

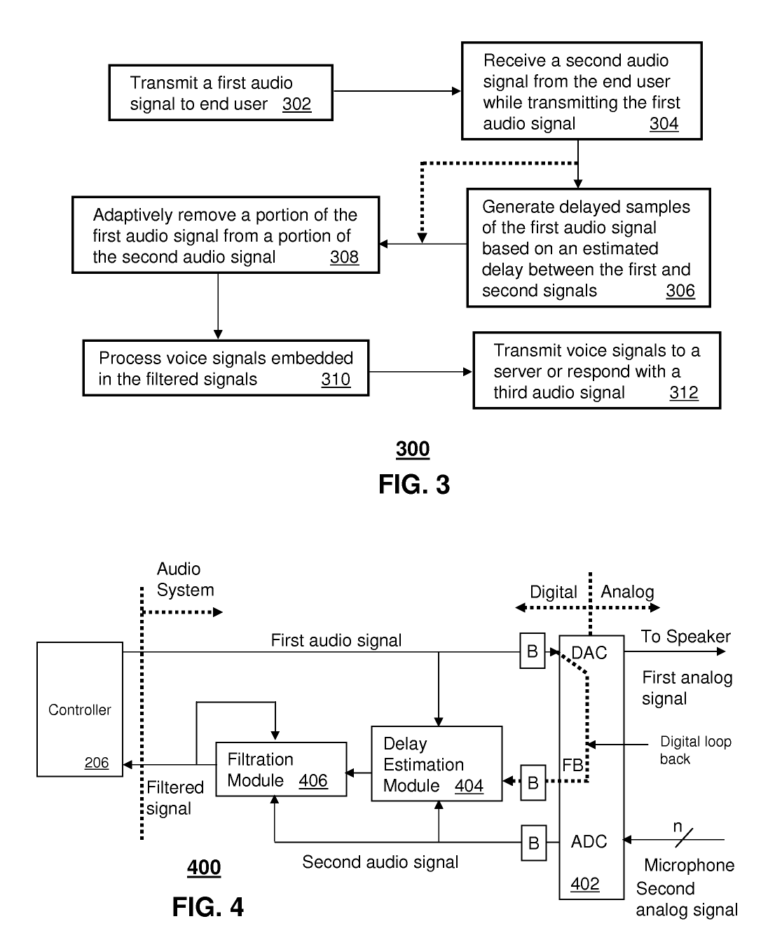

FIG. 2 depicts an exemplary embodiment of the speech processor 102. The speech processor 102 can comprise a wireless transceiver 202, a user interface (UI) 204, a headset 205, a power supply 214, and a controller 206 for managing operations of the foregoing components. The wireless transceiver 202 can utilize common communication technologies to support singly or in combination any number of wireless access technologies of the network 101 including without limitation Bluetooth™, WiFi, WiMax, Zigbee, UWB, SDR, and cellular access technologies such as CDMA-1X, W-CDMA/HSDPA, GSM/GPRS, TDMA/EDGE, and EVDO. SDR can be utilized for accessing public and private communication spectrum with any number of communication protocols that can be dynamically downloaded over-the-air to the speech processor 102. Next generation wireless access technologies can also be applied to the present disclosure.

The UI 204 can include a keypad 208 with depressible or touch sensitive keys, a touch sensitive screen, and/or a navigation disk for manipulating operations of the speech processor 102. The UI 204 can further include a display 210 such as monochrome or color LCD (Liquid Crystal Display) for conveying images to the end user of the speech processor 102, and an audio system 212 for conveying audible signals to the end user and for intercepting audible signals from the end user by way of a tethered or wireless headset 205.

The power supply 214 can utilize common power management technologies such as rechargeable and/or replaceable batteries, supply regulation technologies, and charging system technologies for supplying energy to the components of the speech processor 102 and to facilitate portable applications. The controller 206 can utilize computing technologies such as a microprocessor and/or digital signal processor (DSP) with associated storage memory such a Flash, ROM, RAM, SRAM, DRAM or other like technologies for controlling operations of the speech processor 102.

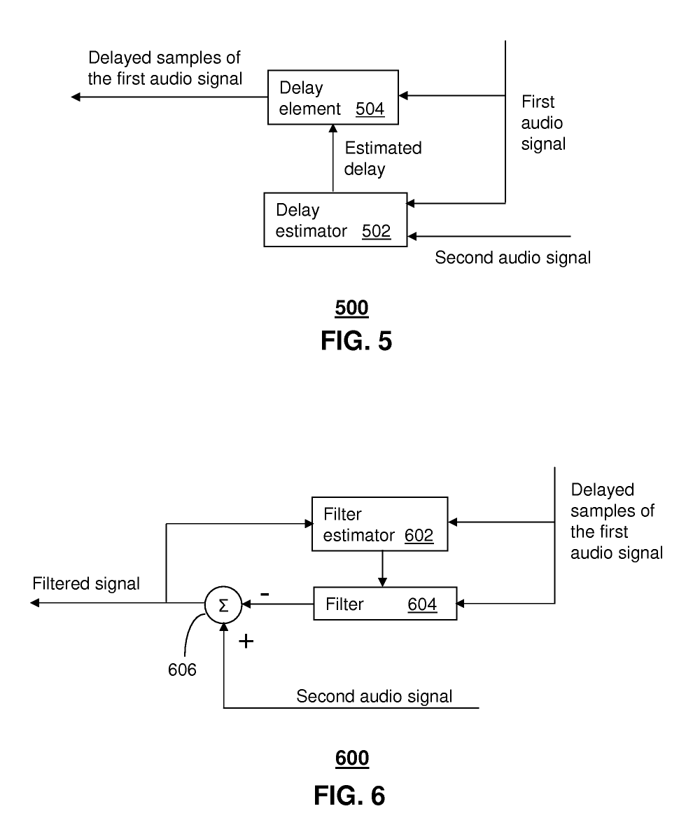

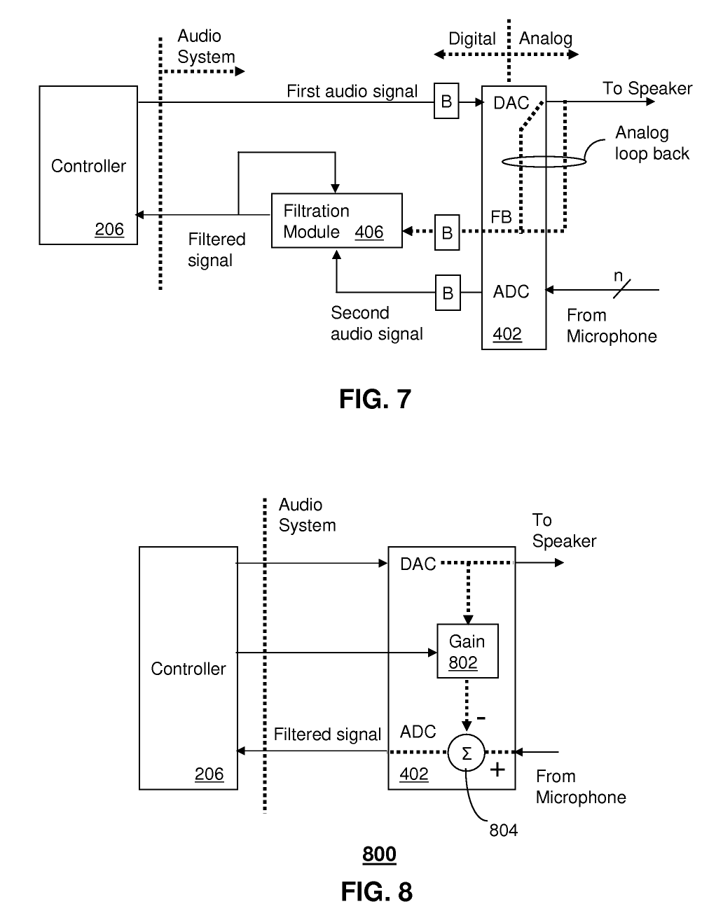

FIG. 3 depicts an exemplary method 300 operating in the speech processor 102. Method 300 can operate in a portion of the speech processor 102 as software, hardware, or combinations thereof. FIGS. 4-8 depict exemplary embodiments of portions of method 300.

With this in mind, method 300 begins with step 302 in which a first audio signal is transmitted to an end user of the speech processor 102. The audio signal can be, for example, a “low battery” chirp or a voice message (such as a logistics command, medical directive, or status) transmitted by way of a speaker or audio transducer circuit of the audio system 212. In applications where the speech processor 102 is configured for full duplex communications, a second audio signal can be received in step 304 by the audio system 212 while the first audio signal is transmitted. The second audio signal can include voice signals of the end user such as a command, or speech responsive to the first audio signal, as well as other ambient sounds.

Because both input and output channels are concurrently active in the audio system 212, leakages, crosstalk, reflections, audio loopback, echoes or any number of other distortions from the first audio signal can be inadvertently injected electrically or electro-magnetically into the second audio signal by, for example, a tethered headset 205 that couples to the audio system 212 with a common ground shared between the speaker and microphone elements of the headset 205. Steps 306-308 can be applied to the speech processor 102 for removing this distortion. In step 306, the audio system 212 can be designed or programmed to generate delayed samples of the first audio signal according to a delay estimated between the first and second audio signals. In step 308, the audio system 212 can be designed to remove a portion of the first audio signal from the second audio signal by using the delayed samples of the first audio signal, the second audio signal, and a filtered received signal generated thereby.

FIG. 4 depicts an exemplary embodiment of steps 306-308. In this embodiment, the controller 206 is coupled to the audio system 212 by way of a digital interface. The audio system 212 comprises a codec 402, a delay estimation module 404 and a filtration module 406. The codec 402 includes a common digital to analog converter (DAC) for transforming digital samples of a first audio signal generated by the controller 206 into a first analog signal. The first analog signal is coupled to a common speaker circuit (not shown) of the audio system 212 for conveying audible signals to the end user.

The codec 402 further includes a common analog to digital converter (ADC) for transforming a second analog signal intercepted by a common microphone (not shown) of the audio system 212 into digital samples representing a second audio signal. The first audio signal can be supplied to the delay estimation module 404 from a feedback path located prior to the codec 402, or from a digital feedback path (FB) within the codec 402.

FIG. 5 depicts an exemplary embodiment of the delay estimation module 404. The delay estimation module 404 can comprise a delay estimator 502 and associated delay element 504 for generating as discussed in step 306 delayed samples of the first audio signal according to an estimated delay between the first and second audio signals. The delay estimator 502 can utilize a common correlator for estimating the delay between the first and second audio signals. The delay element 504 utilizes common technology for delaying digital samples of the first audio signal according to the delay estimated by the delay estimator 502. The delay estimator 404 time-aligns the signals that are received by the filtration module 406 with each other. It estimates and accounts for the difference in time between the first audio signal and the portion of the first audio signal received in the second audio signal. This difference can be due, for example, to asynchronous buffering (depicted by the letter “B” in FIGS. 4 and 7) at the interfaces of the codec 402. In an alternative embodiment, the first audio signal can be constructed by the controller 206 with a marker signal which the delay estimation module 404 can utilize for assessing delay.

The filtration module 406 can comprise an adaptive filter such as, for example, a recursive least squares filter. FIG. 6 depicts an exemplary embodiment of the adaptive filter which comprises a filter estimator 602 and corresponding filter 604 coupled to a difference element 606. The filter 604 can be instantiated as a finite impulse response (FIR) filter (herein referred to as FIR filter 604). The filter estimator 602 can comprise a recursive least squares estimator for adjusting the filter coefficients of the FIR filter 604. The FIR filter 604 generates according to the delayed samples of the first audio signal and the coefficients determined by the filter estimator 602 a signal that approximates the portion of the first audio signal embedded in the second audio signal. Accordingly, the difference element 606 removes in whole or in part the portion of the first audio signal embedded in the second audio signal thereby generating the filtered signal which is in large part free of the distortions introduced by the first audio signal.

FIG.7 provides an alternative embodiment to the embodiment of FIG. 4. In this embodiment, the first audio signal is fed back in analog form through the codec or by way of an external input channel thereby incurring the same or similar delay as the portion of the first audio signal that exists in the second audio signal. With a predictable delay applied to the first audio signal by way of the loopback internal or external to the codec 402, the delay estimator can be removed and the filtration module 406 can operate as described earlier. This approach can be utilized when the two audio input channels (i.e., the second audio signal and the looped back first audio signal ) are synchronized. The second audio signal and the looped back first audio signal can be synchronized much like left and right stereo input channel signals are commonly synchronized in time.

FIG. 8 provides yet another alternative embodiment for steps 306-308 in which a common gain element 802 included in the codec 402 feeds back an adjusted first audio signal into a difference element 804 which removes in whole or in part a portion of the first audio signal embedded in the second signal thereby generating the filtered signal. This difference operation can be performed on either analog or digital signals. In this embodiment, the controller 206 can be programmed to perform signal processing on the filtered signal similar in operation to the filter estimator 602 and thereby adjust the gain element 802 to remove the embedded first audio signal in the incoming second audio signal.

Once the second audio signal has been filtered as described by the foregoing embodiments of FIGS. 4-8, voice signals of the end user can be processed by the controller 206 in step 310 of FIG. 3 according to common voice processing techniques (e.g., speech recognition, speaker identification, speaker verification, and so on). According to the voice signal supplied by the end user, the controller 206 can be programmed in step 312 to transmit the processed voice signal to the server 104 of FIG. 1 (as text or unadulterated speech), or it can respond to said voice signals with a third audio signal. In a logistics or medical services application, for example, the end user's voice signals can represent commands or responses to commands emanating from the server 104, or locally within the speech processor 102.

It would be evident to an artisan with ordinary skill in the art that the aforementioned embodiments of method 300 for removing distortion associated with the first audio signal embedded in the second audio signal can be modified, reduced, or enhanced without departing from the scope and spirit of the claims described below. For example, all or a portion of the delay estimation module 404 and filtration module 406 can be embedded in the codec 402 or the controller 206. Additionally, a portion of the controller 206 can be embedded in the codec 402 also. System 400 can be utilized as a single chip solution embodied in a computing device or audio headset. Similarly, all or a portion of the delay estimation module 404 and filtration module 406 can be implemented in software, hardware or firmware. These are but a few examples of modifications that can be applied to the present disclosure. Accordingly, the reader is directed to the claims below for a fuller understanding of the breadth and scope of the present disclosure.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A speech processor, comprising an audio system for audibly transmitting a rendition of a message, and for removing a portion of the rendered message embedded in a received signal as a result of at least one among electrical and electromagnetic interference between the rendered message and the received signal, thereby generating a filtered received signal, wherein the audio system captures the received signal while audibly transmitting the rendered message.

2. The speech processor of claim 1, wherein the interference is caused in part by coupling a headset to output and input channels of the speech processor, wherein the headset comprises a speaker element that receives the rendered message by way of the output channel, and a microphone element that captures and conveys the received signal to the input channel.

3. The speech processor of claim 1, wherein the interference comprises at least one among an echo, a reflection, a leakage path and crosstalk in the audio system associated with audibly transmitting the rendered message.

4. The speech processor of claim 1, comprising a controller that manages a transceiver, wherein the rendered message comprises at least one among a command received from a server, and a local command generated by the controller.

5. The speech processor of claim 1, wherein the audio system comprises:
a coder and decoder (codec) for transmitting the rendered message to the end user by way of an audio transducer, and for receiving an input audio signal that contains at least one among a response signal from the end user and ambient sound, wherein the input audio signal corresponds to the received signal; and
a filtration module for generating the filtered received signal, wherein the filtration module removes the portion of the rendered message from the received signal using samples of the rendered message supplied by a feedback path in the audio system, the received signal, and the filtered received signal.

6. The speech processor of claim 5, wherein the filtration module comprises an adaptive filter.

7. The speech processor of claim 6, wherein the adaptive filter comprises a recursive least squares filter.

8. The speech processor of claim 1, comprising a controller, wherein one among the controller and the audio system adds a marker to the message transmitted to the end user, thereby facilitating removal of the portion of the message within the received signal.

9. The speech processor of claim 1, wherein the audio system comprises:
a codec for transmitting the audible message to the end user, and for receiving an input audio signal that contains one among a response signal from the end user and ambient sound, wherein the input audio signal corresponds to the received signal;
a delay estimation module for generating delayed samples of the rendered message according to an estimated delay between the rendered message and the received signal; and
a filtration module for generating the filtered received signal, wherein the filtration module removes the portion of the rendered message from the received signal by using the delayed samples of the rendered message, samples of the received signal, and samples of the filtered received signal.

10. The speech processor of claim 9, wherein the delay estimation module comprises a delay estimator and a corresponding delay element for generating the delayed samples of the rendered message, and wherein the filtration module comprises a filter estimator, a corresponding filter, and a difference element for generating the filtered received signal.

11. The speech processor of claim 10, wherein the delay estimator comprises a correlator, wherein the filter estimator comprises a recursive least squares estimator, and wherein the filter comprises a finite impulse response (FIR) filter.

12. The speech processor of claim 5, wherein the feedback path of the message is located in the codec.

13. The speech processor of claim 1, comprising a controller for processing voice signals of the end user embedded in the filtered received signal.

14. The speech processor of claim 13, wherein the controller recognizes a voice message from said voice signals, and is programmed to perform one among a group of tasks comprising directing a wireless transceiver of the speech processor to transmit the voice message to a server managing operations of an enterprise, and responding to the voice message with an audible second message transmitted to the end user.

15. The speech processor of claim 1, wherein the speech processor is utilized in one among a logistics application, and medical services application.

16. A computer-readable storage medium in a speech processor, comprising computer instructions for:
transmitting a first audio signal to an end user while receiving a second audio signal; and
removing from the second audio signal a portion of the first audio signal embedded therein as a result of at least one among electrical and electromagnetic interference between the first audio signal and the second audio signal when coupling a headset to output and input channels of the speech processor, thereby generating a filtered signal.

17. The storage medium of claim 16, comprising computer instructions for adaptively removing the portion of the first audio signal from the second audio signal by using samples of the first and second audio signals, and the filtered signal generated thereby.

18. The storage medium of claim 16, comprising computer instructions for:
generating delayed samples of the first audio signal according to an estimated delay between the first and second audio signals; and
adaptively removing the portion of the first audio signal from the second audio signal by using the delayed samples of the first audio signal, samples of the second audio signal, and samples of the filtered signal generated thereby.

19. The storage medium of claim 17, wherein the samples of the first audio signal correspond to samples from a feedback path in a coder-decoder (codec) of the speech processor.

20. The storage medium of claim 16, wherein the headset is further coupled to a common ground of the speech processor.

21. A coder-decoder (codec), comprising:
a digital to analog converter (DAC) for converting a first digital audio signal to a first analog audio signal;
an analog to digital converter (ADC) for receiving a second analog audio signal while a portion of the first analog audio signal is being transmitted, and for generating a second digital audio signal therefrom; and
a filter for removing from at least one among the second analog and digital audio signals a portion of at least one among the first digital and analog audio signals, thereby generating a filtered signal.

22. The codec of claim 21, wherein the filter comprises a filtration module for generating the filtered signal, wherein the filtration module removes the portion of at least one among the first digital and analog audio signals from one among the second analog and digital audio signals by using samples of at least one among the first digital and analog audio signals, at least one among the second analog and digital audio signals, and the filtered signal.

23. The codec of claim 21, wherein the filter comprises:
a delay estimation module for generating delayed samples derived from an estimated delay between one among the first analog and digital audio signals and one among the second analog and digital audio signals; and
a filtration module for generating the filtered signal, wherein the filtration module removes the portion of at least one among the first digital and analog audio signals from one among the second analog and digital audio signals by using the delayed samples, samples of at least one among the second analog and digital audio signals, and samples of the filtered signal.

24. The codec of claim 21, wherein the codec is embodied in one among a computing device and an audio headset.

25. The codec of claim 21, wherein the filter comprises a gain element and a difference element for removing the portion of at least one among the first digital and analog audio signals from at least one among the second analog and digital audio signals, thereby generating the filtered signal.
